(19) United States
(12) Patent Application Publication
(10) Pub. No.: US 2006/0158880 A1
(43) Pub. Date: Jul. 20, 2006

(54) Multicolor fairy light having a lampshade with rhombus faces

(76) Inventor: Yong-Tie Jian, Banciao City (TW)

Correspondence Address: INTELLECTUAL PROPERTY / TECHNOLOGY LAW, PO BOX 14329, RESEARCH TRIANGLE PARK, NC, 27709, US

(21) Appl. No.: 11/037,722

(22) Filed: Jan. 18, 2005

(51) Int. Cl. F21V 9/00

(52) U.S. Cl. 362/231

(57) ABSTRACT

A multicolor fairy light includes a lamp stand and a lampshade that are rotationally jointed. A lamp as a light source is installed on the lamp stand, and the surface and periphery of the lampshade are diamond-like rhombus faces which transmit gorgeous light as a result of refraction to increase the beauty of the fairy light.

### FIELD OF THE INVENTION

The present invention relates to a fairy light including a lamp stand and a lampshade that are rotationally jointed, of which the lamp stand is made of insulating materials such as hard plastics, and the lampshade is made of high transparent materials such as acrylic resin with diamond-like rhombus faces on its surface and periphery.

### BACKGROUND TO THE INVENTION

At present day, a light used for decorating, for example, on a Christmas tree, is usually a common light bulb capable of flashing, strings of which are hung on the Christmas tree and flashing. Although such seems very glorious as well, yet it is never proposed to provide a lampshade for further dazzling the light on the luminous body. It will be very dazzlingly beautiful if a transparent lampshade having diamond-like rhombus faces on its surface is provided over the lamp.

### SUMMARY OF THE INVENTION

The fairy light of the present invention is thus designed by rotationally jointing a lamp stand and a lampshade, in which an IC-enabled colorific lamp is installed on a lamp stand with a transparent lampshade having diamond-like rhombus faces on its surface and periphery covered thereon so as to enable the light more glorious as a result of the principle of refraction.

### BRIEF DESCRIPTION OF THE DRAWINGS

The structure of the present invention will now be described by referring to the accompanying drawings, in which:

FIG. 1 shows the fairy light;

FIG. 2 shows the lampshade;

FIG. 3 shows the lamp stand;

FIG. 4 is a front view of the lampshade;

FIG. 5 is a top view of the lampshade;

FIG. 6 is a bottom view of the lampshade; and

FIG. 7 is a sectional view of the lampshade, taken alone line 7-7 from FIG. 5.

### DESCRIPTION OF PREFERRED EMBODIMENTS

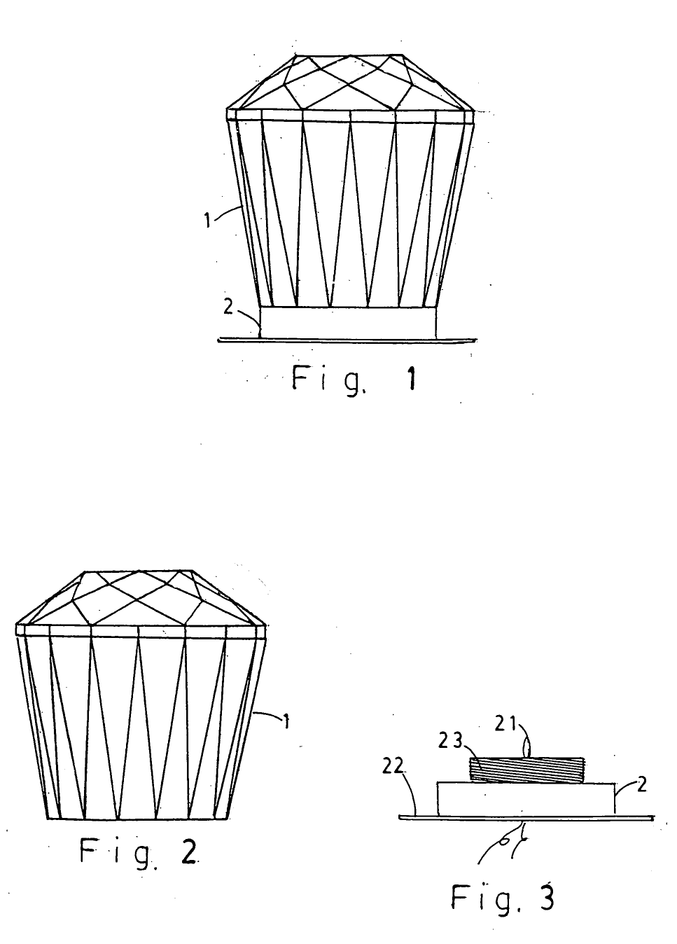

FIG. 1 shows a preferred embodiment of the present invention which is composed of a lampshade 1 as shown in FIG. 2 and a lamp stand 2 as shown in FIG. 3. The lampshade 1 is made of an acrylic resin having high level of transparency; the surface thereof is diamond-like and is composed of a plurality of rhombus faces thereon and on its periphery. A lamp 21, preferably a multicolor colorific lamp capable of flashing, is installed on the lamp stand 2. Such a multicolor colorific lamp is commercially available and generally known as an IC-enabled colorific lamp and widely used for decorating a Christmas tree. There are installation buttons 22 provided on both sides of the lamp stand 2 for hanging, and the lamp stand 2 is provided with threads 23 thereon so that the lamp stand 2 can be rotationally jointed with the lampshade 1.

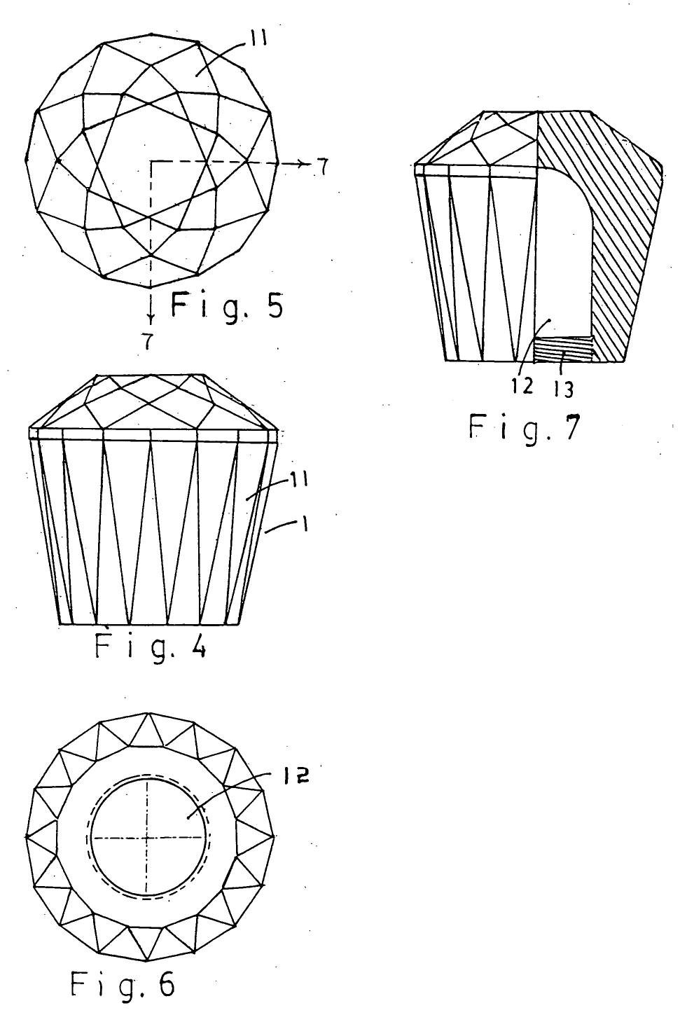

FIG. 4 is a front view of the lampshade, FIG. 5 is a top view of the lampshade, FIG. 6 is a bottom view of the lampshade, and FIG. 7 is a sectional view taken alone line 7-7 from FIG. 5. The lampshade 1 is made of materials having high level of transparency such as an acrylic resin. The surface and the periphery of the lampshade 1 are composed of a plurality of rhombus faces 11 having different angles so that the appearance is very graceful; meanwhile, when the lamp inside the lampshade 1 lights up, the light goes through the lampshade 1 and is refracted by the rhombus faces of different angles to make each of the rhombus faces appear a cluster of or a bunch of colors so that the whole fairy light becomes a resplendent light ball composed of a plurality of flower-like colors, which is very gorgeous and beautiful. There is no doubt that if a Christmas tree is decorated by the fairy lights of the present invention instead of conventional flashing bulbs, the degree of beauty will be greatly different. There is a space 12 in the center of the lampshade 1, and internal threads 13 are provided on the lower inner side of the space 12 so as to be rotationally jointed with the lamp stand 2 as shown in FIG. 3. The size of the fairy light of the present invention is changeable, depending on the conditions of decoration, provided that the space 12 inside the lampshade 1 can receive the lamp. The size of the common IC-enabled colorific lamp at present is very small, and thus the fairy light of the present invention can be also made as small as possible to be used on the string of lamps for a very small Christmas tree; yet the effect of beauty thereof is much better when compared with the conventional string of lamps.

The applicant possesses the technique of acrylic resin casting, and thus can manufacture the fairy light of the present invention from his own factory or cooperate with other factories.

What is claimed is:

1. A multicolor fairy light having a lampshade with rhombus faces, including of a lamp stand and a lampshade that are rotationally jointed, in which the lamp stand is provided with a lamp capable of lighting, and the lampshade is made of high transparent materials such as an acrylic resin, which is characterized in that the lampshade has a space, internal threads are provided on the lower inner side of the space, and the surface and periphery of the lampshade are diamond-like rhombus faces which transmit gorgeous light as a result of refraction.
